(19) United States
(12) Patent Application Publication
(10) Pub. No.: US 2008/0072771 A1
(43) Pub. Date: Mar. 27, 2008

(54) Spreading device and method for automatically distributing ingredients on top of a dough base

(75) Inventor: Alois Marchl, Waldkraiburg (DE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: MULTIPOND Wagetechnik GmbH, Waldkraiburg (DE)

(21) Appl. No.: 11/825,150

(22) Filed: Jul. 5, 2007

(30) Foreign Application Priority Data
Jul. 6, 2006 (DE) 102006031495.6

(51) Int. Cl. A23L 1/00; A21C 9/08

(52) U.S. Cl. 99/494; 426/665

(57) ABSTRACT

The invention relates to a spreading device and a method for automatically spreading ingredients onto a dough base, assuring an even distribution of the ingredients in an automated process.

A device for spreading ingredients like grated/shredded cheese, ham, sausage, meet, fish, vegetables, etc., on top of a dough base like a pizza base, cake base or the like has a supporting member (100) being arranged above the dough base while in use. The supporting member (100) comprises a provisioning container (160) provided with a shutter, the provisioning container being capable of containing a predetermined amount of ingredients, and at least one rake with teeth (124), which is adapted to spread the ingredients while dropping along an ingredients path.

### BACKGROUND OF THE INVENTION

The invention relates to a spreading device, and particularly to a spreading device spreading ingredients evenly on top of a pizza base, cake base, or the like.

### SUMMARY OF THE INVENTION

To achieve a high grade of automation in the field of producing ready-to-eat pizzas, it is necessary to automate also the process of spreading ingredients on top of a dough base. In particular, there is a problem in that an even distribution of the ingredients on top of the dough base is not always carried out reliably.

The object of the invention is to solve this problem. In particular, the object is to provide a device, which makes it possible to evenly spread ingredients on top of a dough bases in an automated manner.

This object is solved by a device according to claim 1 and by a method according to claim 26. Further advantageous developments are subject-matter of the sub-claims.

The invention provides a device for spreading ingredients like grated/shredded cheese, ham, sausage, meet, fish, vegetable, etc. on top of a dough base like a pizza base, cake base or the like, the device comprising a supporting member being arranged above the dough base while in use and including a provisioning container, capable of containing a predetermined amount of ingredients, and at least one rake, which is adapted to spread or disperse ingredients evenly.

Advantageously, the invention comprises an ingredients spreading well including the at least one rake and preventing parts of the ingredients to bypass the at least one rake.

An even better result of spreading the ingredients can be achieved by provisioning a further rake which is arranged such that its teeth are oriented orthogonally to the teeth of the first rake and by overlapping the teeth of the rakes.

A further improvement of the result of spreading can be achieved by provisioning further rakes being arranged opposite the present rakes and the teeth of which being oriented in parallel with the opposing rakes.

To further improve the result of spreading, it is advantageous that one or more rakes pivot-in into the ingredients dropping path against the dropping direction.

To prevent the ingredients from sticking to the rakes, it is advantageous that the teeth of one or more rakes pivot-out of the ingredients dropping path with the dropping direction, wherein advantageously the pivoting of multiple rakes is executed synchronously.

To reduce loss of ingredients by ingredients falling down over the edge of the dough base, it is respectively advantageous to provide a hopper attached on top of the ingredients spreading well and/or a shield. To enhance this result, the shield is embodied as a lowering shield being lowerable onto the dough base.

For purposive emptying the provisioning container, it includes advantageously one or more synchronously operated opening flaps, the opening speeds of which are variable. For a better pre-spreading of the ingredients, the opening flaps are oriented horizontally in a closed state.

For being able to approach different positions, in particular for being able to follow a dough base placed on a continuously moving conveying belt, the supporting member advantageously is a cradle placed on a frame with tracks where the cradle is moved by a motor and advantageously is moved by means of a toothed belt.

Advantageously for an automated processing, a conveying belt adapted to move a dough base or the like is used as a part of the device.

For rapid automated processing, advantageously, a combination weigher is used for dosewise weighing of the ingredients.

For supporting a smooth cooperation of the members, a controller is used, comprising control drivers for the belt motor, the cradle motor, at least one rake motor and/or solenoid valves, respectively.

According to the invention, a method is presented, comprising opening a provisioning container for giving out ingredients, pivoting-in at least one rake into the dropping path of the ingredients and pivoting-out the at least one rake out of the dropping path of the ingredients.

The result can be increased in efficiency, if one or more of the following steps are previously executed, like lowering a lowering shield onto the dough base and aligning the dough base by the lowering shield, minimizing the relative speed between dough base and cradle, detecting the dough base by a sensor, transporting a dough base on a conveying belt.

A higher grade of automation can be achieved by executing, as a subsequent method, one or both steps of raising the lowering shield and moving back the cradle to its initial position.

The invention will be described by means of an embodiment with reference to the Figures.

### BRIEF DESCRIPTION OF THE DRAWINGS

FIG. 1 shows a diagonal view of a device of an embodiment of the spreading device according to the invention.

FIG. 2 shows a diagonal view of an ingredients spreading well and a provisioning container of an embodiment.

FIG. 3 shows a diagonal view of an ingredients spreading well and a provisioning container of an embodiment.

FIG. 4 shows a partly sectional side view of a cradle and a frame of an embodiment.

FIG. 5 shows a front view of a cradle of an embodiment.

FIG. 6 shows a bottom view of a cradle of an embodiment.

### DETAILED DESCRIPTION OF THE PREFERRED EMBODIMENTS

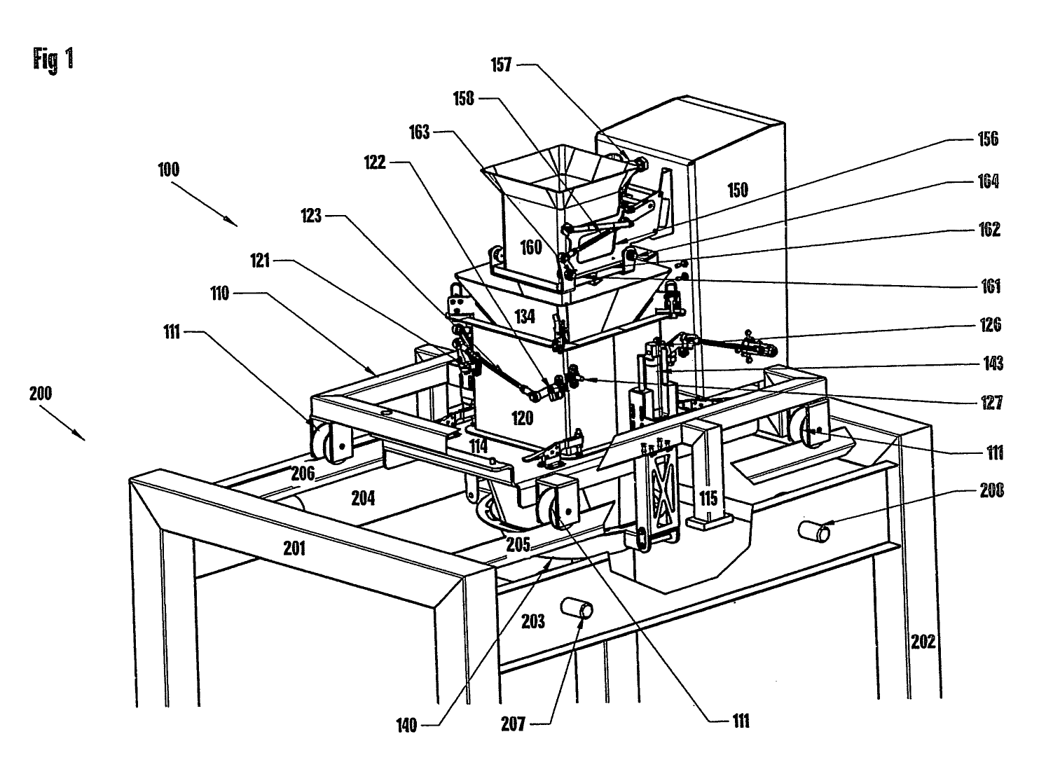

As shown in FIG. 1, the device according to the invention comprises a cradle 100, a frame 200, a combination weigher (not shown), a conveying belt (not shown) and a controller box (not shown).

In the following, firstly the cradle 100 of the device according to the invention is described by means of FIGS. 1 to 6.

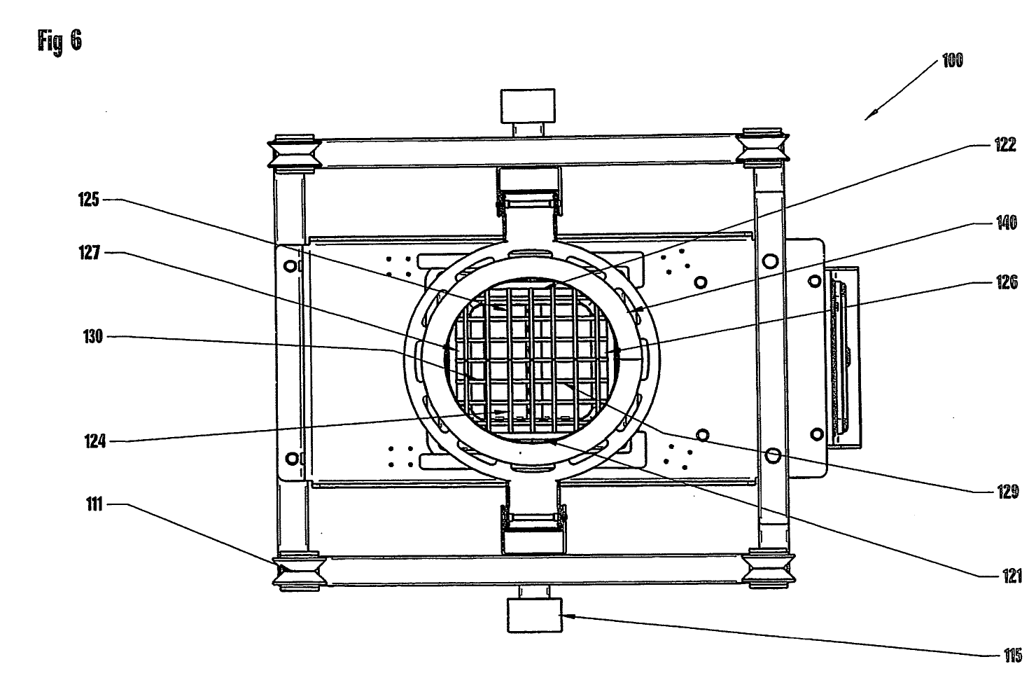

According to FIG. 1, the cradle 100 comprises a rectangular frame 110, being oriented horizontally. Four rollers 111 are attached to the frame by four U-shaped mountings. Thus, the cradle 100 can move left and right with regard to FIG. 1 (in the following, indications of directions related to the whole device, like front, back, left and right are used related to the direction of motion of the cradle 100, wherein a moving direction of the cradle 100 to the left related to FIG. 1 is regarded as direction of motion or “to front”). In the cradle frame 110 a bottom 114 is provided. On the bottom 114, a basically rectangular ingredients distribution well 120 is arranged oriented vertically, pierces the bottom 114 and tapers below the bottom 114 to approximately circular shape (see FIG. 6). Two axles 121, 122 are oriented in parallel to the direction of motion of the cradle 100 and pierce the ingredients spreading well 120 near the right and the left side wall thereof, respectively. The axles 121 and 122 are pivotable and are connected by a linkage 123 in such a way that they pivot synchronously in opposing senses of rotation.

As shown in FIG. 6, teeth 124 and 125 are attached to the axles 121 and 122, respectively, such that teeth 124 and axle 121, teeth 125 and axle 122 form rakes, respectively, being pivotable about the axles 121, 122.

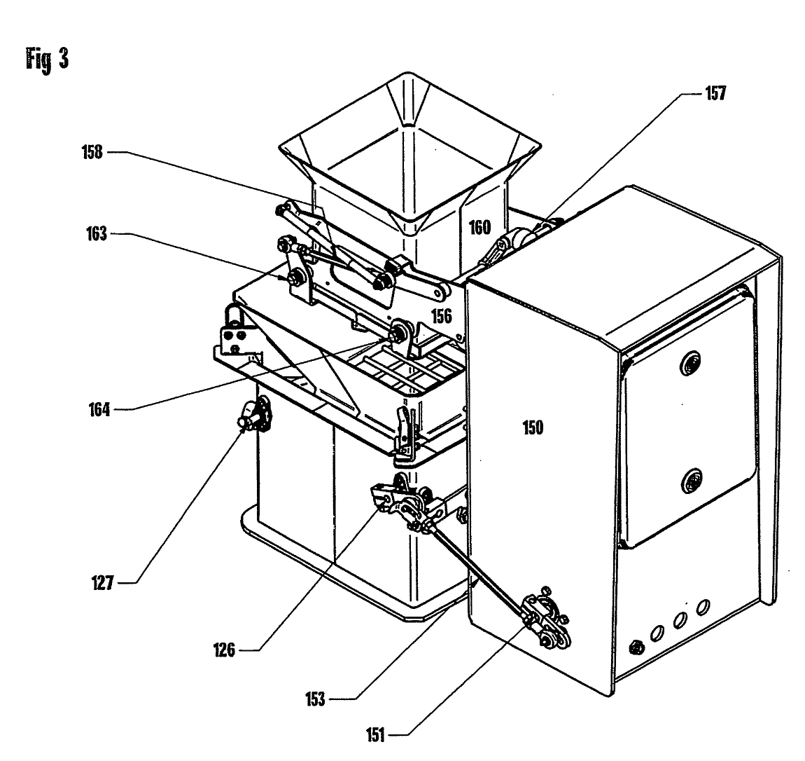

Further, in FIGS. 1 and 3, axles 126, 127, a linkage 128 and teeth 129, 130 in FIG. 6 are arranged in the same manner like the previously described axles 121, 122, the linkage 123 and the teeth 124, 125 and only differ in that the axles 126, 127 are arranged orthogonally to the direction of motion of the cradle 100 and pierce the ingredients spreading well 120 near the front and the rear wall thereof, respectively, slightly above the axles 121, 122.

As it can be seen e.g. from FIG. 1, on the ingredients spreading well 120 at the top end thereof, a rectangular hopper 134 is arranged such that ingredients dropping in from above are centered to the center of the ingredients spreading well 120.

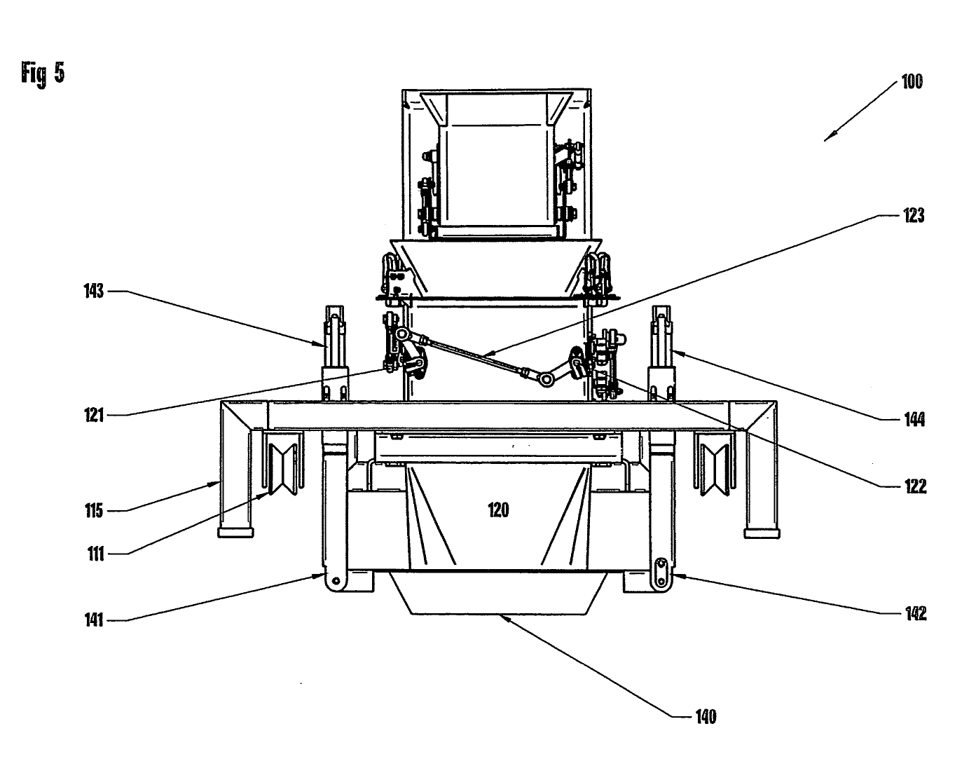

The lower end of the ingredients spreading well 120 is enclosed by the lowering shield 140 (see FIGS. 5, 6), substantially having the shape of an open truncated cone. The lowering shield 140 is connected with the cradle frame 110 by supports 141, 142 and pneumatic cylinders 143, 144 (see FIG. 5). The lowering shield 140 can be moved vertically by the pneumatic cylinders 143, 144.

According to FIG. 1, a housing 150 is arranged on top of the cradle frame 110.

The housing includes solenoid valves (not shown) for controlling the pneumatic cylinders 143, 144, 157 as well as an electric motor (not shown), the shaft 151 of which pierces the cover of the left side of the housing 150, and an electric motor (not shown), the shaft 152 of which pierces the front cover of the housing.

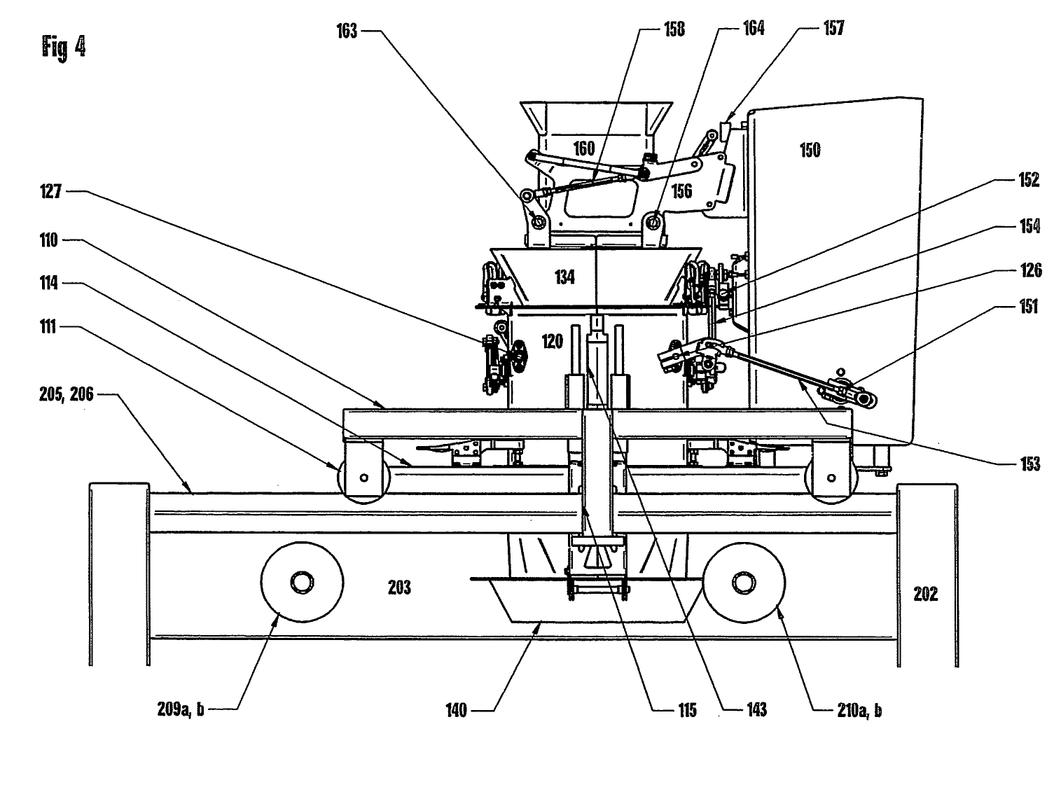

The shaft 151 is connected with the axle 126 by the linkage 153 in such a way that a rotation of the shaft 151 is transmitted to the axle 126 (see FIG. 3). In the same manner, the shaft 152 is connected to the axle 122 by the linkage 154 in such a way that a rotation of the shaft 152 is transmitted to the axle 122 (see FIG. 4).

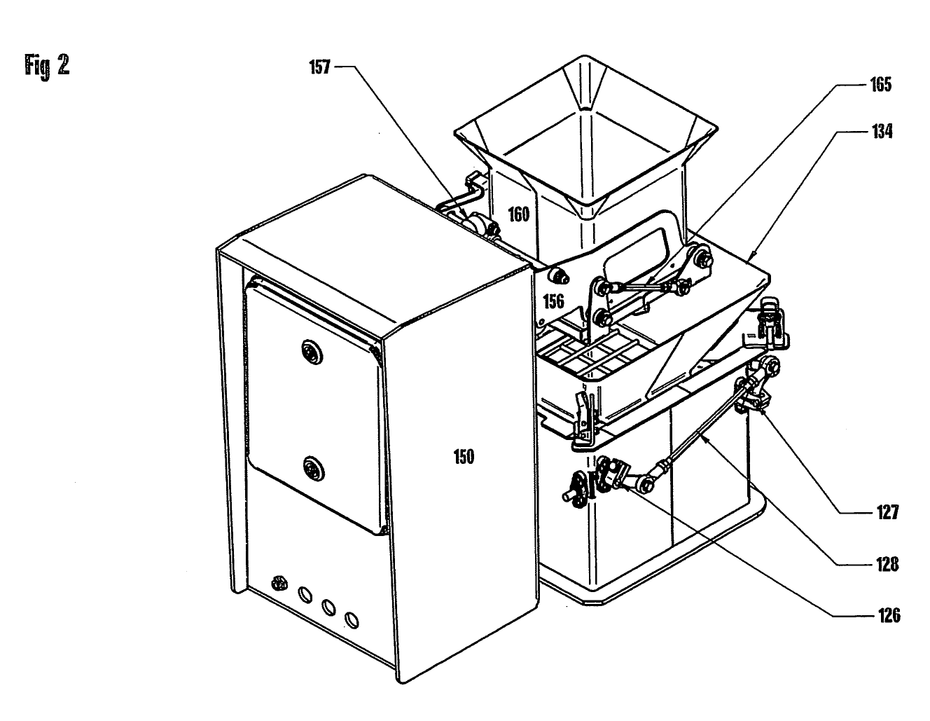

As it can be seen e.g. in FIGS. 2 and 4, a cuboid-shaped provisioning container 160 is connected with the housing 150 by a framing 156 and is carried by the housing 150. The provisioning container 160 is closed on the lower side by two opening flaps 161, 162 (see FIG. 1), the opening flaps being pivotably supported by the axles 163, 164. The two opening flaps 161, 162 are horizontally oriented in a closed state. The axles 163, 164 are connected by a linkage 165 (see FIG. 2) in such a way that the flaps rotate synchronously in opposing directions. A pneumatic cylinder 157 is connected to the axle 163 by a linkage 158 in such a way that an extension movement of the pneumatic cylinder 157 is converted in a rotation of the axle 163.

In the following, the frame 200 of the device is described referring to FIGS. 1 and 4.

The frame 200 consists of two supports 201, 202 being assembled of square pipes and forming reversed U-shapes, respectively. The supports 201, 202 are connected by connecting supports 203, 204, having basically a low U-section. Further, both supports 201, 202 are connected by two tracks 205, 206 extending left and right in the direction of motion and having an interval corresponding to the interval of the rollers 111 of the cradle 100. The tracks 205, 206 consist of square pipes being oriented on edge, respectively. On these tracks 205, 206, the cradle 100 is placed with its rollers 111 and is movably supported to front and back. An axle 207 pierces and connects the connecting supports 203, 204 near the support 201. The axle 207 supports two pulleys 209a, 209b near the connecting supports 203, 204, respectively. An axle 208 pierces and connects the connection supports 203, 204 near the support 202 and is provided with pulleys 210a, 210b, accordingly. Both pulleys 209a, 209b of the axle 207 are connected with the pulleys 210a, 210b of the axle 208 by toothed belts (not shown), respectively. The toothed belts are connected with the cradle frame 110 by a left arm and a right arm 115, respectively. The toothed belts are driven by a not shown servo motor.

A conveying belt (not shown) passes through the frame 200 below the supports 201, 202 from front to back.

A controller box (not shown) includes control drivers for the belt motor, the cradle motor, both rake motors and the solenoid valves for the pneumatic cylinders 143, 144, 157, respectively.

A combination weigher (not shown) is arranged above the provisioning container 160 and portions the ingredients.

In the following, a method for spreading ingredients onto the dough base is described.

In an initial position, the cradle 100 is placed near the support 202. The teeth 124, 125, 129, 130 hang down vertically alongside the side walls of the ingredients spreading well 120, respectively. The provisioning container 160 is closed on its lower side by the horizontally oriented opening flaps 161, 162 and is charged with a dose of ingredients destined to be spread on one single dough base.

The dough base is conveyed on a conveying belt from an oven for pre-baking to an oven for final baking. Meanwhile, the dough base is detected in its movement by a sensor. The detection triggers a movement of the cradle 100 in direction of motion. By this, the cradle 100 is moved by the cradle motor via the arms 115 and the toothed belts. The speed of the cradle 100 is matched with the speed of the belt such that the cradle 100 moves synchronously above the dough base.

By extending the pneumatic cylinders 143, 144 the lowering shield 140 is lowered onto the dough base, whereby the dough base is aligned exactly. A dose of the ingredients provided by the combination weigher is contained in the provisioning container 160. By extending the pneumatic cylinder 157, flap 161 is pivoted about axle 163 by the linkage 158. At the same time, flap 162 is pivoted about axle 164 in an opposite direction by linkage 165. By the pivoting of the flaps 161, 162, the provisioning container 160 is opened. The ingredients contained in the provisioning container 160 drop out of the provisioning container 160, are centered by the hopper 134, and drop into the ingredients spreading well 120.

At the same time, the teeth 124, 125, 129, 130 of the rakes are pivoted in against the dropping direction into the dropping ingredients. This happens by rotating axle 126 by a rotation of shaft 151 transmitted by the linkage 153 in such a way that teeth 129, initially hanging down alongside the side wall of the ingredients spreading well 122 from the axle 126 are pivoted upwardly up to a basically horizontal orientation. At the same time, the rotation is transmitted to the axle 127 by the linkage 128 in such a way that the teeth 130 thereof formerly hanging down alongside the side wall of the ingredients spreading well 120 from the axle 127, are also pivoted upwardly in an approximately horizontal orientation against the rotational direction of axle 126. Shortly afterwards, a rotation of the axle 122 is carried out corresponding to a rotation of the shaft 152 transmitted by the linkages 154, 123, which causes the teeth 124, 125 to be pivoted in a horizontal orientation. Thus, the teeth 124, 125, 129, 130 form a kind of coarse riddle. By passing the riddle and by effect of the movement to the ingredients while pivoting-in the teeth, the ingredients are spread evenly over the diameter of the ingredients spreading well.

Shortly afterwards, the teeth 124, 125, 129, 130 of the rakes are pivoted out in accordance with the dropping direction, such that residues of the ingredients sticking to the teeth drop down too. The process of pivoting-out is carried out analogous to the process of pivoting-in except for an inversed order with inversed rotational directions.

The ingredients drop down further and are centered to the dough base by the lowering shield 140.

After finishing the dropping process of the ingredients, the lowering shield 140 is raised again by the pneumatic cylinders 143, 144, the cradle 100 stops and moves back to its initial position.

While moving back the cradle 100, the combination weigher weighs a new dose of ingredients for the next cycle.

This process is repeated with the detection by the sensor of every further dough base.

1. Device for spreading ingredients like grated/shredded cheese, ham, sausage, meat, fish, vegetables, onto a dough base like a pizza base, cake base or the like,
comprising a supporting member being arranged above the dough base while in use, the supporting member comprising:
a provisioning container provided with an openable shutter and capable of containing a predetermined amount of ingredients, and
at least one rake with teeth, being adapted to spread ingredients while the ingredients drop down along an ingredients dropping path.

2. Device according to claim 1, comprising an ingredients spreading well including the at least one rake.

3. Device according to claim 2, wherein the teeth of the at least one rake protrude basically horizontal into the ingredients dropping path.

4. Device according to claim 3, comprising a further rake, which is arranged such that the teeth of the further rake are oriented basically orthogonal with respect to the teeth of the at least one rake.

5. Device according to claim 4, wherein the teeth of the further rake overlap with the teeth of the at least one rake.

6. Device according to claim 1, comprising a further rake being arranged opposite to the at least one rake in the ingredients spreading well.

7. Device according to claim 6, wherein the teeth of the further rake in the ingredients dropping path are oriented in parallel to the teeth of the at least one rake.

8-14. (canceled)

15. Device according to claim 1, wherein the shutter comprises at least one opening flap.

16. Device according to claim 15, wherein the shutter comprises a further opening flap and a synchronizing mechanism, by means of which the opening flaps are synchronously pivotable.

17. Device according to claim 15, wherein the opening flap is oriented horizontally in a closed state.

18. Device according to claim 15, characterized by an opening mechanism, which is adapted to vary the opening speed of the opening flap.

19. Device according to claim 1, wherein the supporting member is a cradle.

20. Device according to claim 19, comprising a frame with at least one track, which is adapted to carry and/or guide the cradle.

21. Device according to claim 19, comprising a servo motor being adapted to move the cradle.

22. Device according to claim 21, comprising a toothed belt, which is adapted to transfer a drive force of the servo motor to the cradle.

23. Device according to claim 1, comprising a conveying belt, being adapted to move a dough base or the like.

24. Device according to claim 1, comprising a combination weigher for dosewise weighing the ingredients.

25. (canceled)

26. Method for plating a dough base by means of a device according to claim 1, comprising the steps:
opening the provisioning container for giving out ingredients, while the dough base is arranged below the provisioning container,
pivoting-in the at least one rake into the ingredients dropping path, and
pivoting-out the at least one rake out of the ingredients dropping path.

27. Method according to claim 26, wherein the pivoting-in of the at least one rake into the ingredients dropping path is carried out at the time of dropping down of the ingredients.

28. Method according to claim 26, as a method executed prior to the steps according to the claim 26, comprising:
lowering the lowering shield onto the dough base, and
aligning the dough base by the lowering shield.

29. Method according to claim 25, containing as a previously executed step a minimization of the relative speed between the dough base and the supporting member.

30. Method according to claim 26, comprising as a previously executed step a detection of the dough base by a sensor.

31. Method according to claim 26, comprising as a previously executed step transporting of a dough base by a conveying belt.

32. Method according to claim 28, comprising as an afterward executed step a raising of the lowering shield.

33. (canceled)

34. Device according to claim 5, comprising further rakes being arranged opposite to the respective at least one rake and the further rake in the ingredients spreading well.

35. Device according to claim 1, wherein the teeth of the at least one rake are arranged pivotable-in against the dropping direction into the ingredients dropping path.

36. Device according to claim 1, wherein the teeth of the at least one rake are arranged pivotable-out of ingredients dropping path in accordance with the dropping direction.

37. Device according to claim 6, characterized by a pivoting device, by means of which the teeth of the at least one rake and the further rake are pivotable synchronously.

38. Device according to claim 2, wherein the ingredients spreading well comprises a hopper being adapted to center the ingredients to the ingredients dropping well.

39. Device according to claim 2, comprising a lowering shield which is arranged below the ingredients spreading well and which is adapted to center the ingredients while the ingredients drop down onto the dough base arranged therebelow.

40. Device according to claim 39, characterized by a lowering device, which is adapted to lower the lowering shield onto the dough base.
